(19) United States
(12) Patent Application Publication
(10) Pub. No.: US 2004/0256846 A1
(43) Pub. Date: Dec. 23, 2004

(54) Gas generator assembly

(75) Inventors: Karsten Kahler, Aschaffenburg (DE); Georg Schonhuber, Oberneukirchen (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/864,175

(22) Filed: Jun. 9, 2004

(30) Foreign Application Priority Data
Jun. 17, 2003 (DE) 203 09 360.7

(51) Int. Cl. B60R 21/26

(52) U.S. Cl. 280/740

(57) ABSTRACT

A gas generator assembly comprises a gas generator having an outer housing and a diffuser provided as a separate unit outside the gas generator and having a wall with through-flow openings and a filter arranged on the wall. The wall does not have a through-flow opening in a region of the filter.

### BACKGROUND OF THE INVENTION

The invention relates to a gas generator assembly.

Known gas generator assemblies are part of a gas bag module and comprise a gas generator having an outer housing and a diffuser provided as a separate unit outside the gas generator. The diffuser has a wall and a filter arranged on the wall. Between the gas generator and the diffuser surrounding it, a diffuser space is produced, into which the gas flows before it inflates the gas bag. In order to reduce filter material in the gas generator, it is known to provide one or more filters in the diffuser. These filters are arranged in front of the outflow openings in the wall of the diffuser. The gas flows through the filter and arrives on the rear side directly to the through-flow openings.

A further reason why filters are housed outside the gas generator in the diffuser is the temperature of the particles which are to be filtered out. These particles are often still fluid in the gas generator and can not be sufficiently filtered there. Only with the exit of the gas from the gas generator do the particles pass into the solid phase.

### SUMMARY OF THE INVENTION

The invention provides a gas generator assembly which is distinguished by a good filtering action.

The gas generator assembly according to the invention comprises a gas generator having an outer housing and a diffuser provided as a separate unit outside the gas generator and having a wall with through-flow openings and a filter arranged on the wall. The wall does not have a through-flow opening in a region of the filter, i.e. the wall is gas tight in the region where the filter is contacting the wall which is usually the rear and radial outer side of the filter. Contrary thereto, in the known gas generator assemblies, which were mentioned above, through-flow openings are provided in the wall of the diffuser immediately to the rear side of the filter, the wall in accordance with the invention does not permit any exit of gas in the region of the filter, i.e. behind the filter. According to the invention, the gas arrives into the filter, is deflected by the wall and flows through the filter laterally. This means that the filter is flowed through uniformly almost over its entire volume and has a good filtering and cooling action. The gas generator is a closed unit which, without further adjacent parts, does withstand the internal pressure generated therein upon activation of the gas generator. Further, the diffuser is not immediately connected with the gas generator.

In the preferred embodiment, provision is made that the outer housing of the gas generator has outflow openings and the filter is arranged lying opposite the outflow openings, in order to have generated gas from the gas generator flowing directly against it. No further intermediate wall or diffuser plate is provided between the outflow openings and the filter. As the gas flows directly into the filter, it undergoes a cooling very rapidly.

The filter completely surrounds the gas generator peripherally in the region of its outflow openings, as is preferably provided.

The diffuser can be constructed in a cup shape, the filter here being arranged on the inner side against the peripheral wall of the diffuser.

The through-flow openings in the cup-shaped diffuser are preferably in the peripheral wall and/or in the end wall.

### BRIEF DESCRIPTION OF THE DRAWINGS

Further features and advantages of the invention will be apparent from the following description and from the following drawings, to which reference is made.

In the drawings:

FIG. 1 shows a cross-sectional view through a steering wheel gas bag module with a gas generator assembly according to the invention and

FIG. 2 shows an enlarged view of the gas bag module with the gas generator assembly according to the invention in accordance with FIG. 1.

### DETAILED DESCRIPTION OF THE PREFERRED EMBODIMENT

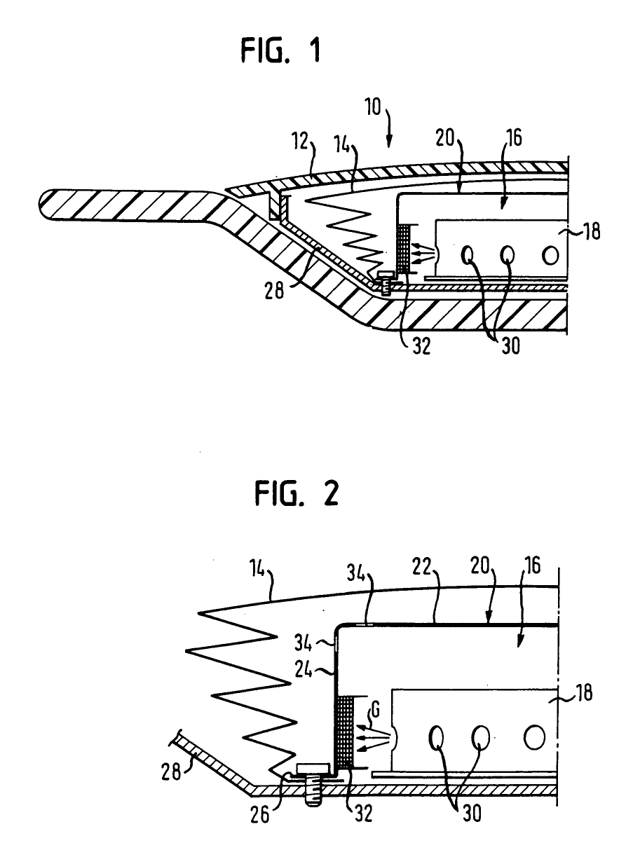

In FIG. 1 a vehicle steering wheel is illustrated in half-section, which has a gas bag module 10. A folded gas bag 14 is arranged under the covering cap 12. In the gas bag 14, in turn, a gas generator assembly 16 is arranged. The gas generator assembly 16 consists of a cylindrical gas generator having an outer housing 18 and of a cup-shaped diffuser 20 of sheet metal. The diffuser 20 is a component separate from the gas generator and surrounding it, which is spaced apart from the outer housing 18 in radial and axial direction.

The diffuser 20 has an end wall 22, a peripheral wall 24 adjoining thereto, and a radial ring flange 26 adjoining at the lower end of the peripheral wall 24. The edge of the gas bag 14 defining the inflation opening of the gas bag 14 is clamped between the underside of the ring flange 26 and a module trough 28. The gas generator is likewise fastened to the module trough 28.

On the inner side of the peripheral wall 24 of the diffuser 20, a filter is fastened, and namely lying immediately opposite the outflow openings 30 in the outer housing 18. The filter, which bears reference number 32, completely surrounds the gas generator in the region of the outflow openings 30 and has a height, measured in axial direction, which is greater than the diameter of the outflow openings 30.

The peripheral wall 24 does not have a through-flow opening behind the filter 32, i.e. in the contact region of the filter 32. Through-flow openings 34 are only provided above the filter 32 in the peripheral wall 24 and/or in the end wall 22.

On activation of the gas generator, gas G leaves its outer housing 18 and firstly meets the filter 32, which it flows through radially, in order to be finally deflected by the wall 24 and to flow through the filter in axial direction. The gas G is cooled, and the particles contained in the gas remain in the filter 32. The gas finally leaves the diffuser 20 via the through-flow openings 34, in order to unfold the gas bag 14.

The filter can consist of metal, ceramic or plastic material, it can have coarsely and/or finely structured sections, with free spaces and intermediate spaces. Embodiments of the filter 32 are knitted meshes, lattices, perforated sheets, fine fleeces, lamellar sheets etc.

1. A gas generator assembly, with
a gas generator having an outer housing (18) and
a diffuser (20) provided as a separate unit outside said gas generator and having a wall with through-flow openings (34) and a filter (32) arranged on said wall,
characterized in that
said wall does not have a through-flow opening (34) in a region of said filter (32).

2. The gas generator assembly according to claim 1, wherein said outer housing (18) has outflow openings (30) and said filter (32) is arranged opposite to said outflow openings (30), in order to have generated gas from said gas generator flowing directly against it.

3. The gas generator assembly according to claim 1, wherein gas generator having outflow openings (30) and wherein said filter (32) completely surrounds said gas generator peripherally in a region of said outflow openings (30).

4. The gas generator assembly according to claim 1, wherein said diffuser (20) has a cup shape with an end wall (22) and a peripheral wall (24).

5. The gas generator assembly according to claim 4, wherein said filter (32) is arranged on an inner side of said peripheral wall (24) of said diffuser (20).

6. The gas generator assembly according to claim 4, wherein said through-flow openings (34) are provided in said peripheral wall (24) of said cup-shaped diffuser (20).

7. The gas generator assembly according to claim 4, wherein said through-flow openings (34) are provided in said end wall (22) of said cup-shaped diffuser (20).
